(19) United States
(12) Patent Application Publication
(10) Pub. No.: US 2012/0056144 A1
(43) Pub. Date: Mar. 8, 2012

(54) Expandable gate system

(76) Inventors: Kenneth R. Woods, Iola, TX (US); Kathy M. Woods, Iola, TX (US)

(21) Appl. No.: 13/136,974

(22) Filed: Aug. 16, 2011

Related U.S. Application Data
(60) Provisional application No. 61/402,915, filed on Sep. 7, 2010.

(51) Int. Cl. E06B 11/06; E06B 11/02

(52) U.S. Cl. 256/73

(57) ABSTRACT

An expandable gate system is described in which (a) a main gate section comprises a plurality of parallel horizontal tubes each having an open end, and (b) a corresponding plurality of horizontal rails on a second section which are slidingly received in the open ends of the tubes of the main section. After the sliding section has been telescoped outwardly to its desired position, the sliding section can be secured to the main section to prevent further movement.

### CROSS-REFERENCE TO RELATED APPLICATION

This application is based upon, and claims priority from, my Provisional Application No. 61/402,915, filed Sep. 7, 2010.

### FIELD OF THE INVENTION

This invention relates to gates and gate systems. More particularly, this invention relates to gate installations and uses for agricultural purposes.

### BACKGROUND OF THE PRIOR ART

Conventional gates and panels are manufactured in a fixed length, e.g. 8 feet long, 10 feet long, 12 feet long, etc. There may be as many as about six or eight different fixed lengths of gates manufactured and made available for sale to satisfy the needs of the various customers who purchase such gates at a variety of farm and ranch retail outlets, lumber yards, home improvement centers, etc. Normally such types of gates are made available in fixed lengths and increase by two feet increments.

Situations do arise from time to time where a fixed length gate is not the correct length for the opening to be filled. For example, the opening which is to be filled may be 15 feet wide, or 14.5 feet wide. In those situations, a conventional 14 feet wide gate is too short, and the next size larger gate (i.e. 16 feet) is too long. As a result, neither commercially available gate is suitable for that application. As a result, either one or both of the support posts will have to be reset, or a short section of fence could be constructed to fill in the resulting gap, all at considerable time and expense.

There has not heretofore been provided a gate system which is capable of fitting an opening other than the standard opening of 8 feet, 10 feet, 12 feet, etc.

### SUMMARY OF THE INVENTION

In accordance with the present invention there is provided an expandable gate system which is capable of accommodating openings other than the standard 8, 10, 12, 14, 16 feet, openings. In one embodiment, the gate system comprises two sections which are telescoped together to enable one end of a first section to be fixed (for example, to a support post) while a second section which is telescoped to the first section can be pulled outwardly to expand the length of the gate as needed so as to fill the space or distance between two posts, for example.

In another embodiment, the gate system may include a plurality of telescoping sections which are adapted to slide outwardly from each other so as to provide a longer gate where needed.

In a preferred embodiment, the gate system of the invention comprises a fixed section of hollow parallel tubes and a sliding section comprising an equal number of parallel hollow tubes (or bars) which slide into the open ends of the hollow tubes, respectively, of the first section. For example, the fixed or main gate section may include six parallel tubes or rails, and the telescoping section would also include a corresponding number of six parallel rails which are sized such that they can slide within the openings in the ends of the hollow tubes or rails of the main gate section. The length of the tubes or rails which slide into the open ends of the tubes in the main section may vary as desired. For example, they could be as short as about one foot or as long as eight feet or even more, if desired.

The expandable gate system of the invention greatly reduces the need for a manufacturer to produce gates of several different lengths. Rather, one expandable gate is able to accommodate openings of several different sizes. For example, one expandable gate may be able to accommodate openings ranging from about eight feet up to about 14 or 15 feet. Another expandable gate may be able to accommodate openings of about four feet up to about seven feet or so.

Other advantages and features of the gate system of this invention will be apparent from the following detailed description and accompanying drawings.

### BRIEF DESCRIPTION OF THE DRAWINGS

The invention is described in more detail hereinafter with reference to the accompanying drawings wherein:

FIG. 1A is an elevational view showing the manner in which an expandable gate of this invention can be pivotably attached at one end to a conventional hinge post.

FIG. 1B is an elevational view showing the expandable gate of FIG. 1A in an extended position such that the free end of the gate now reaches across the opening to the latch post where it may be secured with a chain or other closure device.

FIG. 2 is an elevational view of another embodiment of an expandable gate system of this invention.

### DETAILED DESCRIPTION OF THE INVENTION

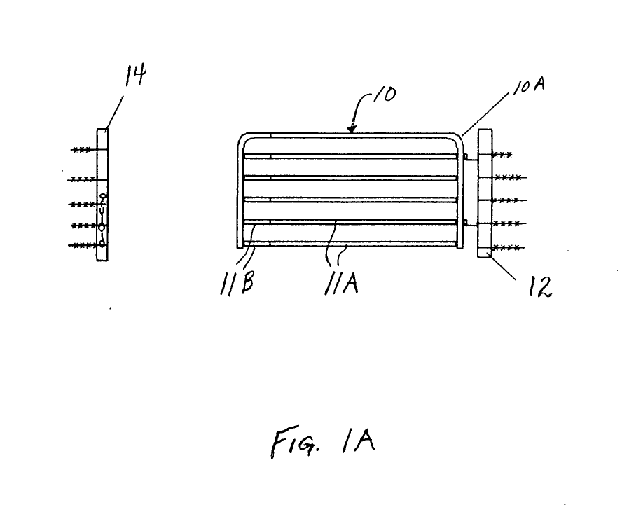

FIG. 1A shows an expandable gate 10 which is pivotably attached at one end 10A to a conventional hinge post 12 in the normal manner. The gate has a plurality of parallel tubes 11A which are horizontally disposed and separated from each other a few inches. The second section of the gate (the sliding section) is comprised of an equal number of tubes or rails 11B as are used in the main section. These tubes or rails have a diameter slightly smaller than that of the tubes of the main section of the gate, and the tubes or rails are appropriately spaced so as to correspond with the position of the open ends of the tubes on the main section. This enables the tubes of the sliding section to fit into the open ends of the tubes of the main section. In FIG. 1A the sliding section of the gate is shown in its retracted position.

FIG. 1B illustrates the gate system of FIG. 1A in an expanded position where the free end of the gate is now in close proximity to the latch post 14. The slidable section of the gate, which was telescoped inside the main section of the gate, has been pulled outwardly so as to fill the length of the opening between the hinge post and the latch post. The gate may now be fastened to the latch post with chain 15, for example.

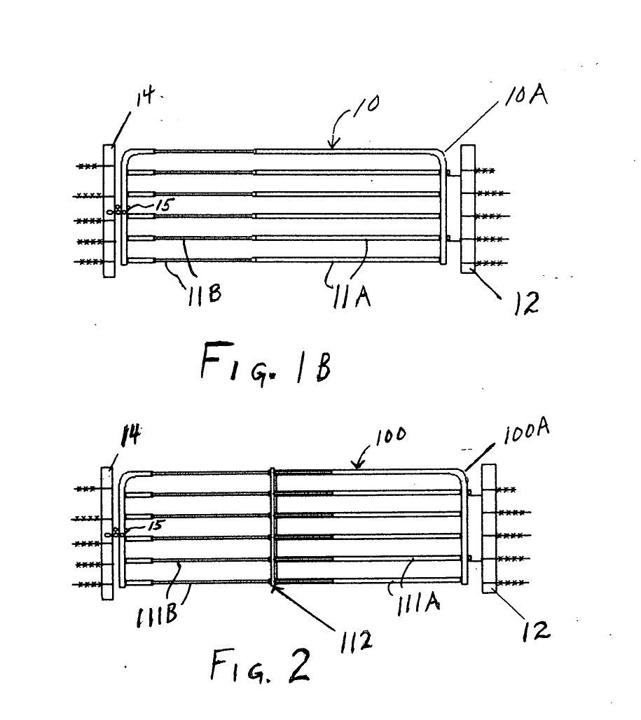

In FIG. 2 there is shown another embodiment of a gate system 100 of the invention. After the sliding section 111B has been telescoped outwardly from section 111A, it may be secured in the desired position in various manners. For example, one may use clamps, compression fittings, self-tapping screws, lynch pins, bolts, set screws, cam locks, or any other type of desired or available fastener in order to assure that the length of the gate remains fixed by preventing the sliding section from moving longitudinally relative to the main section of the gate. It is also possible to use conventional vertical “z” braces 112, as shown in FIG. 2, which are secured by screws which extend through both the outer tube and the inner tube or rail. This secures the position of the sliding outer section 111B of the gate to the inner section 111A.

Thus, the expandable gate system of this invention removes the need to produce or market gates of several fixed lengths (e.g. 6 feet, 8 feet, 10 feet, 12 feet, etc.). This also makes it easier for the retailer because he no longer has to stock gates of several different lengths. Also, the manufacturer no longer has to manufacture all the different lengths of gates. Rather, about three different sizes of expandable gates may take care of all the needs for gates of different lengths.

Other variants are possible without departing from the scope of this invention.

What is claimed is:

1. An expandable gate system comprising:
(a) a main section having a plurality of parallel tubular members each having an open end;
(b) a telescoping section having a plurality of parallel rail members connected at one end to an upright member; wherein said rail members are adapted to be slidingly received in said open end of said tubular members of said main section; wherein said telescoping section is laterally movable relative to said main section.

2. A gate system in accordance with claim 1, wherein said telescoping section is adapted to be secured to said main section when said gate system is at a desired length.

3. A gate system in accordance with claim 2, wherein said telescoping section is adapted to be secured to said main section by means of one or more mechanical fasteners.
